(19) United States
(12) Patent Application Publication
(10) Pub. No.: US 2001/0011225 A1
(43) Pub. Date: Aug. 2, 2001

(54) Internet subscription system for providing appointment management for small businesses

(76) Inventors: Patrick Thomas O'Connor, Prundale, CA (US); Donald Rex Boys, Aromas, CA (US)

Correspondence Address: CENTRAL COAST PATENT AGENCY, PO BOX 187, AROMAS, CA, 95004, US

(21) Appl. No.: 09/814,010

(22) Filed: Mar. 20, 2001

Related U.S. Application Data
(62) Division of application No. 09/323,599, filed on Jun. 1, 1999.

(51) Int. Cl. G06F 17/60

(52) U.S. Cl. 705/9; 705/11

(57) ABSTRACT

of the Disclosure An Internet-enabled appoint and reservation service system includes an Internet-connected appointment server executing a software suite, and one or more subscribing businesses to the service, the businesses having receiving apparatus enabling receipt of appointment schedules from the appointment server. The appointment server presents an interactive interface to browsing clients, the interactive interface enabling the clients to select the businesses and make an appointment or reservation with the businesses, and wherein the appointment server periodically provides updated appointment schedules to the subscribing businesses via the receiving apparatus. Subscribing businesses may operate with a personal computer connecting to the server. Businesses are grouped on the server into geographic groups and clients are enabled to select groups, then individual businesses, and then to accomplish appointments.

### FIELD OF THE INVENTION

The present invention is in the field of Internet subscription services and pertains more particularly to a service for managing appointments for small businesses.

### CROSS-REFERENCE TO RELATED DOCUMENTS

The present application is a divisional application of cop ending patent application serial number 09/323,599, entitled “Internet Subscription for Providing Appointment Management for Small Business”, which was filed on Jun. 1, 1999, and which is incorporated herein in its entirety.

### BACKGROUND OF THE INVENTION

There are many small businesses that provide service to consumers in a time-appointed manner, such that individuals are scheduled to appear at an office or other service outlet on a particular day at a particular time to be availed of the service the business provides. There are examples far to numerous to list, such as doctors, dentists, barbers, hairdressers, nail services, oil changers, and many, many more. These types of businesses include restaurants and night clubs, for example, who make reservations for Clients.

More and more in the present age small businesses that perform largely on an appointment schedule are computer-equipped, and many use one or more computers for scheduling and tracking appointments. These same computers are more often than not also connected by a data modem to a telephony channel, and are Internet capable.

In the kinds of businesses to which the present invention may apply, often a dedicated employee deals with the public and manages the appointment schedule. In those businesses wherein the scheduling does not require a full-time person, at least a large part of one employee's time is required. The total use of employee's time over hundreds of businesses is therefore quite large and expensive, as there is no means of sharing employee's time among unrelated businesses.

What is clearly needed is an Internet subscription service accessible and usable by small businesses, allowing consumers to call and schedule appointments, the service having software for managing appointments for many businesses and updating schedules periodically to member businesses.

### SUMMARY OF THE INVENTION

In a preferred embodiment of the present invention an Internet-enabled appoint and reservation service system is provided, comprising an Internet-connected appointment server executing a software suite; and one or more subscribing businesses to the service, the businesses having receiving apparatus enabling receipt of appointment schedules from the appointment server. The appointment server presents an interactive interface to browsing clients, the interactive interface enabling the clients to select the businesses and make an appointment or reservation with the businesses, and wherein the appointment server periodically provides updated appointment schedules to the subscribing businesses via the receiving apparatus.

In preferred embodiments the receiving apparatus at individual ones of the subscribing businesses comprises an Internet-capable personal computer with a video display unit (PC/VDU), and the PC/VDU executes software providing periodic connection to the appointment server, downloading of updated versions of an appointment schedule during the periodic connection, and display of the appointment schedule on the video display unit.

Also in preferred embodiments appointment server groups subscribing businesses into geographically-related groups and presents an interactive series of interfaces to a client allowing the client to select a group. After a client selects a group, the appointment server presents an interactive interface to the client presenting types of businesses in the selected group, enabling the client to select a business type. After the client selects the business type, the appointment server presents an interactive interface indicating individual businesses of the selected type to the client, enabling the client to select an individual business. Finally, after the client selects the individual business, the appointment server presents an interactive interface to the client, allowing the client to make an appointment with the business.

In a preferred embodiment indication of individual businesses includes multimedia advertising material for individual ones of the businesses, and in some embodiments advertising material presents a hyperlink to a direction service for aiding a client in locating the business. Also in some embodiments the appointment server cooperates with a pager facility to page-alert clients of a scheduled appointment. In another aspect of the invention specific methods for practicing the invention are taught.

In embodiments of the invention taught in enabling detail below for the first time a facility is provided whereby browsing clients on the Internet network can make and edit appointments and reservations with many sorts of small businesses worldwide, and small businesses that are primarily service-related and operate in part at least by appointments and reservations can advertise on the Internet and expect to reach a much wider market than previously.

### BRIEF DESCRIPTION OF THE DRAWING FIGURES

FIG. 1 is a block diagram illustrating an exemplary architecture for a service according to a preferred embodiment of the present invention.

FIG. 2 is an exemplary appointment sheet for a business in an embodiment of the invention.

FIG. 3 is an exemplary interactive interface for a client to select a business type.

FIG. 4 is an illustration of exemplary subscriber interactive advertisements.

### DESCRIPTION OF THE PREFERRED EMBODIMENTS

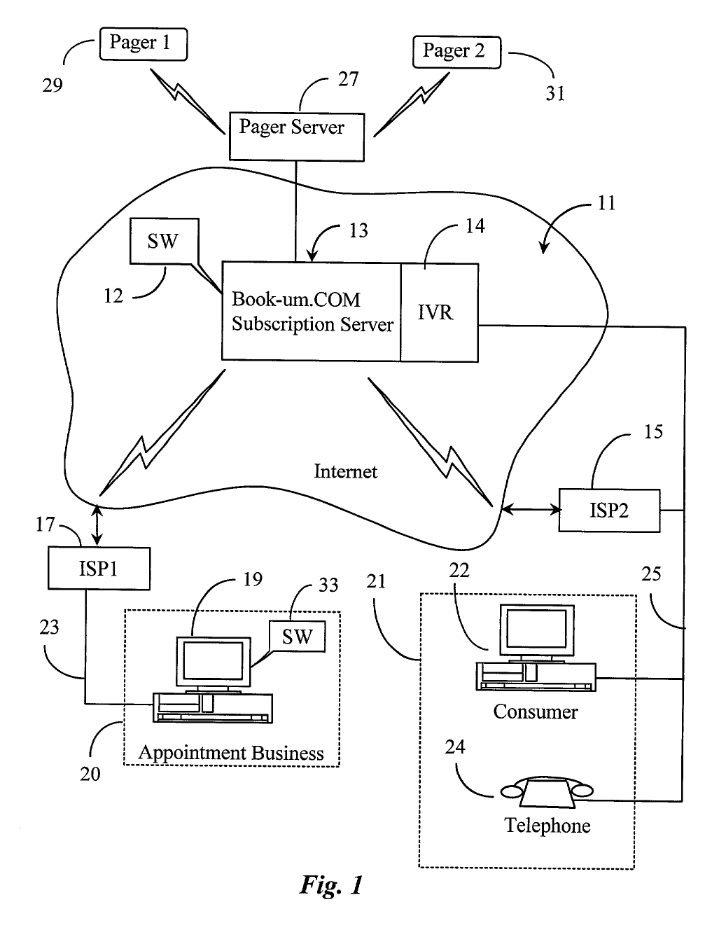

FIG. 1 is a block diagram illustrating an exemplary architecture for an Internet-implemented subscription service according to a preferred embodiment of the present invention. In this system a subscription service is provided on an Internet-connected server 13 in the well-known Internet network represented by cloud 11. Server 13 and the service it provides is known as Book-um.com by the inventor, and operates with software 12 managing appointments for consumers and small businesses, as well as providing small-business indexing and limited advertisement, organized generally on a regional geographic basis.

In this system small businesses subscribe to services provided by server 13. A plurality of such small businesses is represented by a single entity 20 having an Internet-connected PC 19, which connects to Internet network 11 via a telephony modem (not shown but typically provided in PC 19) and a telephony channel 23 through an Internet Service Provider 17 as is well-known in the art.

The small businesses represented by entity 20 are typically businesses that provide services and operate entirely or in large part by appointments with clients. Such businesses include doctors, veterinarians, chiropractors, psychologists, barbers, hairdressers, dog groomers, nail service salons, and many, many more. There are a very large number of such small businesses in the U.S. national economy and worldwide. Each one of these businesses having a PC as illustrated has access to the Internet and to subscription server 13, and in practice of the present invention according to some preferred embodiments will Interact with server 13 through Internet communication, although, as will be seen, Internet capability will not be required in all cases to practice the present invention in some embodiments.

Millions of people now have Internet access and form a large and growing base of potential users and purchasers (consumers) of Internet-offered goods and services. More and more people become Internet-capable every day. In FIG. 1 the worldwide base of millions of Internet-connected potential clients is represented by consumer entity 21 having a PC 22 connected by a telephony modem (not shown) to a telephony channel 25 connecting through an ISP 15 to Internet network 11. For purposes of the present descriptions and examples these consumers are referred to as clients, or potential clients.

In many cases clients as described above also have a telephone which may connect to the same telephony channel as the PC modem, or to a separate channel (separate phone line). For example, a client may have two lines, or an ISDN line offering two channels and control.

Clients as described, assuming browser software, are Internet capable, and may contact and Interact with server 13 just as businesses 20 may do so. It will be apparent to the skilled artisan that the architecture shown for both businesses and consumers (clients) is exemplary, and either may connect to the Internet in another way and using other equipment than a PC.

Referring again to FIG. 1, subscription server 13 executes a unique software suite 12 and is implemented with, or connected to a telephony component providing an Interactive Voice Response (IVR) unit 14. Clients may reach IVR 14 via voice phone 24 and suitable telephony channel. Voice communication to IVR 14 in some embodiments may also be by integrated computer phone (Internet Protocol Network Telephony (IPNT)) over Internet channels. Finally server 13 is also connected to a pager server 27 capable of messaging pagers 29 and 31 which may be carried by clients. Alternatively server 21 may outdial other pager systems and provide messages through those systems. The interactivity of the IVR and pager systems with the subscription server is described in additional detail below.

As previously described, an object of the present invention is to provide an Internet-enabled system whereby clients may review small businesses and schedule appointments for service. To this end the enterprise hosting server 13 elicits subscriptions from small businesses toward handling all or a part of each business's appointment scheduling through software suite 12 and the host apparatus. A business subscriber, typically at time of subscription, provides information comprising a business profile and configuration, which server 13 with software 12 may use in appointment scheduling and updating.

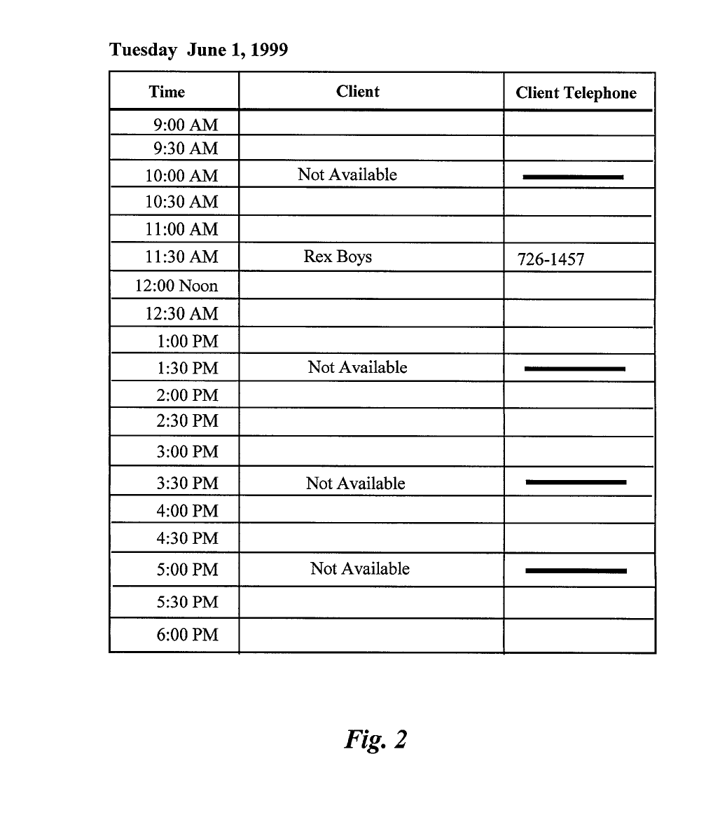

Server 13 provides a selection of schedule formats suitable for a variety of appointment-type businesses, or, if existing formats are not useful for a new subscriber, a new format may be authored as a part of the configuration process for a new subscriber. FIG. 2 is an exemplary schedule sheet for one day for a typical small business, in this case the Prunetree Barber Shop in Prunedale, Calif. In a preferred embodiment a suitable schedule appointment sheet such as that shown in FIG. 2 is provided by software suite 12 for each small business subscriber. Use of these schedule sheets is described in further detail below after introduction of additional elements and features of the present invention.

In a preferred embodiment a client accessing server 13 is first presented with a selection graphic allowing browsing clients to select a consumer area. There are a variety of ways this may be done in different embodiments of the invention. In general subscribing businesses will be grouped in business zones. For example, in large cities the city may be subdivided into several business zones, such as, for New York City as an example, Brooklyn, Midtown Manhattan, Upper East Side, South Bronx, and so forth. Similarly business/consumer zones in more rural areas may be defined by such as county or zip code. Businesses are thus grouped, regardless of type of business, into regional zones defining regions within which clients may be expected to easily travel to keep appointments.

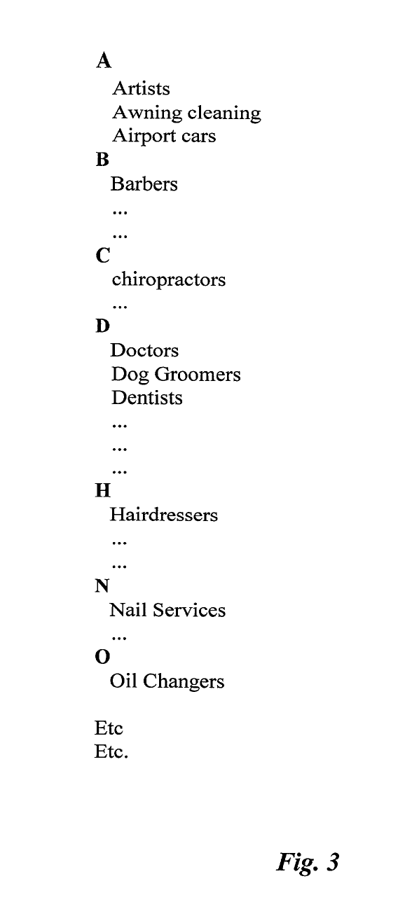

The selection graphic presented to connecting clients may take the form first of a map of the U.S., which, upon selection of a state becomes a new graphic depicting the selected state with hyperlinks for regions within the state, which then, upon selection of a city, for example, presents in a map form with hyperlinks the business/consumer regions within the city. Upon selection of a business/consumer region a top-level index of businesses grouped in that region is presented. An example of such a top-level index is shown as FIG. 3 herein.

It is noted here that there are at least two different situations; one in which browsing clients are seeking services in their own local area, within easy driving distance, for example, of their homes. The other situation is for travelers, wherein a browsing client may have an itinerary, and may wish to contract appointments and reservations in different locales along his/her path of travel. The traveler may, for example, be a female patent attorney living in California, and may be flying to Washington for meetings at the United States Patent and Trademark Office (USPTO), and then be going on the New York City for a strategy conference with litigation attorneys in an action connected with a client. This client may make a reservation for a hairdresser in Washington prior to an appointment with an Examiner at the USPTO, a lunch reservation between appointments, and arrange for clothes to be cleaned overnight in New York prior to the strategy conference, and so on. The difference in locality is handles transparently in preferred embodiments of the invention.

FIG. 3 is an alphabetical list of subscribing small businesses to services of server 13 (FIG. 1) in the business/consumer region a client selects in the process described above. Only a few types of businesses are shown as example, and the list for each business/consumer region may be much larger. In the presentation of FIG. 3 each business type is a hyperlink, and upon selection a client is presented a new page illustrating all of the businesses of a particular type subscribing to the service. It will be apparent to the skilled artisan that the interactive list of FIG. 3 is exemplary, and that there are many other ways the list might be presented and made interactive.

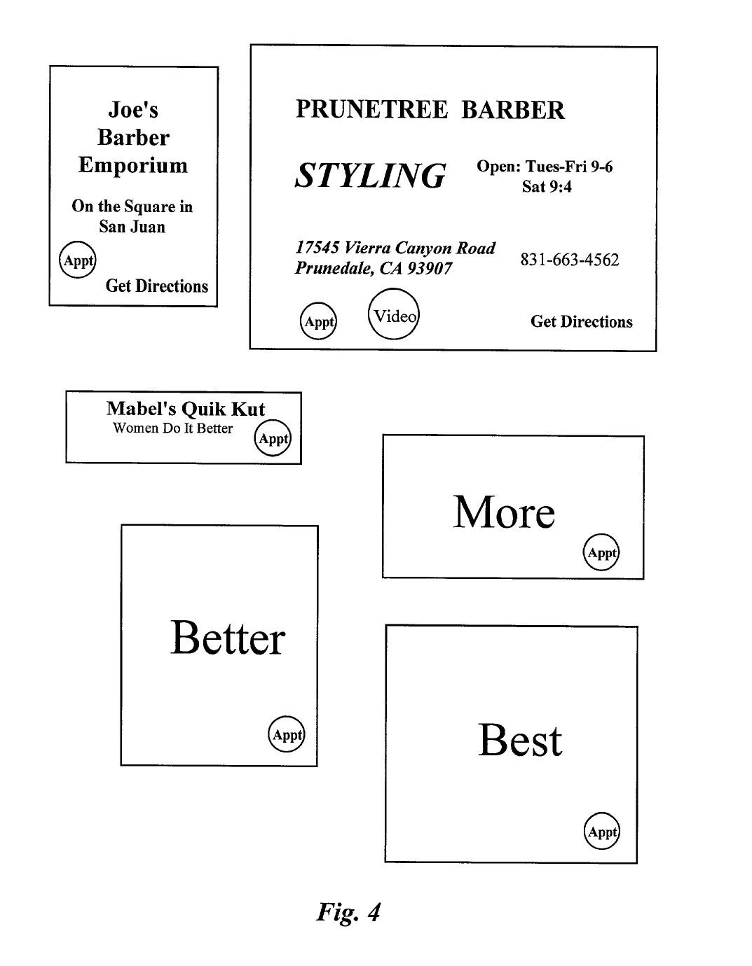

FIG. 4 is an exemplary interactive display presented after a client selects a business type in the interactive display of FIG. 3. In this example each subscribing business presents an advertisement, and each advertisement is implemented with one or more hyperlinks. The enterprise hosting server 13, in the configuration process for a business subscriber, has stored ads and tools for creating new ads that may be used for new subscribers, and old subscribers may update and change (edit) their ads with cooperation from the host, but typically not unilaterally. Typically bigger and fancier ads will cost somewhat more to run. In some embodiments a subscribing business may have multiple ads, for example one more expensive to run on weekends and a peak evening period, and another to run at all other times.

As shown in FIG. 4 typically each ad has a hyperlink labeled Appt for making an appointment. Selecting this link by a client sends the client to an appointment page for the subscriber business hosting the ad, as illustrated in FIG. 2. Other hyperlinks, as shown for example in the Prunetree Ad of FIG. 4, select further multimedia content, such as a video clip, an audio clip (company song, for example), or a map of how to get to the subscriber business (Get Directions). There are many varied possibilities for such advertisement, which will typically be limited by the host of server 13 in interest of fairness. For business subscribers such as restaurants there may be a price variance in reservations, that is, one may reserve a table by a window, near the dance floor, and so on by guaranteeing a different payment.

Referring now to FIG. 2, an appointment (or reservation) sheet as the example shown is presented when a client selects a particular business and initiates the Appt hyperlink. In some embodiments this is a sign-up sheet with entry fields a client may select, and use to enter his/her name and telephone number. In other embodiments different tools may be used, such as an entry window, or a drop-down menu bar system for selection of a time and entry of ID info. There are varied possibilities with the object being to allow a client to make an appointment or reservation with the selected business. Typically to ensure privacy the data is managed so clients accessing the entry mechanism do not have access to any identity information for other clients who have made appointments or reservations. If a list like that shown in FIG. 2 is used, time slots reserved by other clients will be blacked out or indicated as not available, as shown in FIG. 2.

In some embodiments for some subscribing businesses there may be a facility for reserving certain services, products, or classes of services. A client may request of a barbershop in advance, for example, a certain type of haircut, or indicate other preferences with other types of businesses. As another example, subscribing services may indicate in various ways different services and products available, and clients may select among various choices.

In some embodiments a client will be afforded a payment system whereby the client may enter a charge card or some other credit mechanism for payment, and the host of server 13 will handle at least some credit and payment tasks for the subscribing business, typically for a small fee per transaction. In some cases a prepayment may be required for special reservations or appointed services.

Typically a client will be informed of appointment and reservation rules, which may vary for different subscribing businesses, such as the time within which a reservation may be changed or canceled. Clients may be given a password or other secure ID, and may return to a subscribing business' appointment/reservation sheet and cancel or alter appointments. The password is to allow the client to see his/her time slot, rather than being shown the not available displays.

Referring now to FIG. 1, a further service afforded for clients and business subscribers is described. Server 13 is shown as coupled to a pager server 27 which can send messages to multiple pager devices such as devices 29 and 31 illustrated. In this embodiment clients may be invited to enter a pager number, and prior to a scheduled appointment time, software 12 will prepare and cause a pager alert to be sent to the client, to remind the client of the impending appointment. If the pager facility is a two-way facility, clients may respond (a) that appointment will be kept or (b) that appointment will be missed, and can be rescheduled. In the case of missed appointments the system can clear the time slot for a subscribing business and seek to fill it with another client.

In an alternative embodiment clients may subscribe to the service afforded by the enterprise hosting server 13, and be provided with a pager and a pager call number, in which case the pager facility may be integrated with server 13.

As also shown in FIG. 1, server 13 may be coupled with an IVR 14, which is accessible by clients via either a conventional telephone illustrated by telephone 24 or by IPNT telephony via PC 22. In this case clients need not necessarily be Internet-capable to afford themselves of the services provided in embodiments of the present invention. Through interactive voice response telephoning clients may be afforded essentially the same services provided to Internet-browsing clients, but without the advertising variations (multimedia) provided in ads through the Internet connection. In a further embodiment IVR 13 may assume characteristics of a multimedia call center, wherein clients may interact with agents as well as IVR facilities.

Referring again to FIG. 1, subscribing businesses will typically be Internet-connected to server 13. Businesses thus connected in a preferred embodiment are provided with software 33, which presents a graphic interface on the business' computer display, displaying the daily and weekly appointment schedule for the individual business, as provided in the on-line implementations described. This display can take the form shown in FIG. 2, or may assume any of several other formats. In this embodiment, to avoid unnecessary on-time charges, software 33 may transparently connect to the Internet through ISP1 on a periodic basis, say once every one-half hour, and update the appointment display for the business. This in a preferred embodiment will be a two-way negotiation, and need last only seconds. Because most businesses will be making appointments and reservations in other more conventional ways, as well as on-line through the system described in various embodiments herein, the business may update the appointment schedule locally between on-line updates, then at the on-line periodic update, the server system can blank out (not available) appointment slots filled locally. In an alternative embodiment, through software 33 and software 12, a business can make available only specific appointments or reservations to the on-line service, and keep other appointment and reservation slots for local use. The balance may be struck in any of several ways.

Theoretically world-wide appointments and reservations could be handled by a single Internet-connected and enabled server with adequate data storage, computing power and modem capability. The scale of the appointment enterprise is, however, rather large, considering the numbers of businesses in the world who may want to subscribe to the service. Because of the scale it is contemplated by the inventors that a plurality of servers, pager facilities, and IVR and other telephony services will be used to avoid overloading, and intercommunication between the facilities will be provided for load sharing and balancing and the like. In some cases facilities will be provided in world-wide geographic arrangements to provide the best and least expensive alternatives for clients and subscribing businesses.

It will be apparent to the skilled artisan that there are a broad variety of alterations that might be made in the embodiments of the invention described above without departing from the spirit and scope of the invention. Many such variations and alternatives have already been described. For example, ads for subscribing businesses may take many and varied forms, including multimedia aspects. Further, server apparatus may vary in type and form in many different ways, and software implementing the invention may run on different computer apparatus. Still further, it is not strictly required that subscribing businesses maintain an active periodic computer connection to service server 13. Server 13 may download appointment information to a business by other ways, such as by a periodic facsimile or even by telephone through IVR 14. The invention s limited only by the scope of the claims which follow:

What is claimed is:

1. An Internet-enabled appointment and reservation service system, comprising:
an Internet-connected appointment server executing a software suite; and
one or more subscribing businesses to the service, the businesses having receiving apparatus enabling receipt of appointment schedules from the appointment server;
wherein the appointment server presents an interactive interface to browsing clients, the interactive interface enabling the clients to select the businesses and make an appointment or reservation with the businesses, and wherein the appointment server periodically provides updated appointment schedules to the subscribing businesses via the receiving apparatus.

2. The system of claim I wherein the receiving apparatus at individual ones of the subscribing businesses comprises an Internet-capable personal computer with a video display unit (PC/VDU).

3. The system of claim 2 wherein the PC/VDU executes software providing periodic connection to the appointment server, downloading of updated versions of an appointment schedule during the periodic connection, and display of the appointment schedule on the video display unit.

4. The system of claim 1 wherein the appointment server groups subscribing businesses into geographically-related groups and presents an interactive series of interfaces to a client allowing the client to select a group.

5. The system of claim 4 wherein the appointment server, after a client selects a group, presents an interactive interface to the client presenting types of businesses in the selected group, enabling the client to select a business type.

6. The system of claim 5 wherein the appointment server, after a client selects the business type, presents an interactive interface indicating individual businesses of the selected type to the client, enabling the client to select an individual business.

7. The system of claim 6 wherein the appointment server, after the client selects the individual business, presents an interactive interface to the client, allowing the client to make an appointment with the business.

8. The system of claim 6 wherein the indication of individual businesses includes multimedia advertising material for individual ones of the businesses.

9. The system of claim 8 wherein the advertising material presents a hyperlink to a direction service for aiding a client in locating the business.

10. The system of claim 1 wherein the appointment server cooperates with a pager facility to page-alert clients of a scheduled appointment.

11. A method for managing appointments for substantially service-related businesses, comprising steps of:
(a) presenting an interactive interface system to browsing clients by an Internet-connected appointment server executing a software suite, the interactive interface system allowing clients to select among the subscribing businesses and to make an appointment or reservation with selected business; and
(b) periodically downloading an updated appointment schedule by the server to receiving apparatus at the subscribing businesses.

12. The method of claim 11 wherein, in step (b) the receiving apparatus at individual ones of the subscribing businesses comprises an Internet-capable personal computer with a video display unit (PC/VDU).

13. The method of claim 12 wherein in step (b) the PC/VDU executes software providing periodic connection to the appointment server, downloading of updated versions of an appointment schedule during the periodic connection, and display of the appointment schedule on the video display unit.

14. The method of claim 11 wherein in step (a) the appointment server groups subscribing businesses into geographically-related groups and presents an interactive series of interfaces to a client allowing the client to select a group.

15. The method of claim 14 wherein in step (a) the appointment server, after a client selects a group, presents an interactive interface to the client presenting types of businesses in the selected group, enabling the client to select a business type.

16. The method of claim 15 wherein in step (a) the appointment server, after a client selects the business type, presents an interactive interface indicating individual businesses of the selected type to the client, enabling the client to select an individual business.

17. The method of claim 16 wherein in step (a) the appointment server, after the client selects the individual business, presents an interactive interface to the client, allowing the client to make an appointment with the business.

18. The method of claim 16 wherein in step (a) the indication of individual businesses includes multimedia advertising material for individual ones of the businesses.

19. The method of claim 18 wherein in step (a) the advertising material presents a hyperlink to a direction service for aiding a client in locating the business.

20. The method of claim 10 wherein the appointment server cooperates with a pager facility to page-alert clients of a scheduled appointment.
